(19) United States
(12) Patent Application Publication
(10) Pub. No.: US 2008/0292783 A1
(43) Pub. Date: Nov. 27, 2008

(54) METHOD OF MANUFACTURING A THIN LAYER AND METHODS OF MANUFACTURING GATE STRUCTURES AND CAPACITORS USING THE SAME

(75) Inventors: Jun-Hyun CHO, Gyeonggi-do (KR); Jung-Ho LEE, Gyeonggi-do (KR); Youn-Joung CHO, Gyeonggi-do (KR); Jung-Sik CHOI, Gyeonggi-do (KR); Seung-Min RYU, Busan (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 12/102,724

(22) Filed: Apr. 14, 2008

(30) Foreign Application Priority Data
Apr. 13, 2007 (KR) 2007-0036401

(51) Int. Cl. B05D 5/12; B05D 3/04

(52) U.S. Cl. 427/79; 427/337; 427/58

(57) ABSTRACT

In a method of manufacturing a thin layer, an organic metal precursor is provided onto a substrate. The organic metal precursor has a vapor pressure of about 0.5 Torr to about 6 Torr at a temperature of about 65° C. to about 95° C. and is represented by following Chemical Formula 1. An oxidant including an oxygen atom is provided onto the substrate to oxidize the organic metal precursor. The organic metal precursor reacts with the oxidant to form a thin layer including a metal oxide on the substrate. The thin layer may be used for a gate insulation layer of a gate structure, a dielectric layer of a capacitor, etc.

A-MO—R]₃ <Chemical Formula 1>

### CROSS-REFERENCE TO RELATED APPLICATIONS

This application claims priority under 35 U.S.C. §119 to Korean Patent Application No. 2007-0036401, filed on Apr. 13, 2007 in the Korean Intellectual Property Office (KIPO), the contents of which are herein incorporated by reference in their entirety.

### BACKGROUND OF THE INVENTION

1. Field of the Invention

Example embodiments of the present invention relate to a method of manufacturing a thin layer, a method of manufacturing a gate structure, using the method of manufacturing a thin layer, and a method of manufacturing a capacitor, using the method of manufacturing a thin layer. More particularly, example embodiments of the present invention relate to a method of manufacturing a thin layer including a metal oxide, a method of manufacturing a gate structure using the method of manufacturing a thin layer and a method of manufacturing a capacitor using the method of manufacturing a thin layer.

2. Description of the Related Art

Recently, a material having a high dielectric constant (k) (referred to as high-k dielectric) was used for forming a gate insulation layer of a metal-oxide semiconductor (MOS) transistor, a dielectric layer of a capacitor, a dielectric layer of a flash memory device, etc. A thin layer including the material having high-k dielectric may efficiently reduce a leaking current between a gate electrode and a channel or between a lower electrode and an upper electrode with maintaining a thin equivalent oxide thickness (EOT). Furthermore, the thin layer including the material having high-k dielectric may improve a coupling ratio of a flash memory device.

Examples of the material having high-k dielectric may include tantalum pentoxide (Ta₂O5), yttrium oxide (Y₂O₃), hafnium oxide (HfO₂), zirconium dioxide (ZrO₂), niobium oxide (Nb₂O₅), barium titanate (BaTiO₃), strontium titanate (SrTiO₃), etc. The thin layer including the material having high-k dielectric may be formed through atom vapor deposition method using an organic metal precursor.

The organic metal precursor that may be used for forming the thin layer including the metal oxide should satisfy the following conditions. First, the organic metal precursor should have a high vapor pressure at a low temperature and thermal/chemical stability. Second, the organic metal precursor should have a great reactivity with respect to an oxidant so that a ligand may be separated from a metal rapidly and clearly. Third, a vapor deposition ratio of the organic metal precursor should be high, and a residual organic material of the organic metal precursor should not remain on the thin layer after a final reaction. Fourth, the organic metal precursor should have a liquid phase and to be non-toxic. Fifth, the organic metal precursor should have a high purity, and a manufacturing cost of the organic metal precursor should not be expensive, and the vapor deposition temperature of the organic metal precursor should be appropriate. However, conventional organic metal precursors do not fully satisfy the above-mentioned conditions. For example, a conventional organic metal precursor including tetraethyl lead (Pb(C₂H₅)₄) is explosive and toxic, and a conventional organic metal precursor including a metal alkoxide is not stable against moisture, and a conventional organic metal precursor including halide is not appropriate for manufacturing a semiconductor. Furthermore, a conventional organic metal precursor including β-diketonate is relatively expensive, and has a low vapor pressure, and exists in a solid phase at a room temperature. Recently, research has been conducted on hexafluoropentane dionate (HFAC) and hexafluorodimethyloctane dionate (HFOD), which have a higher vapor pressure. However, HFAC and HFOD have a low reactivity with an oxidant so that a ligand is not easily separated from a metal. Furthermore, since HFAC and HFOD have a high molecular weight, HFAC and HFOD have a low vapor deposition rate.

Recently, tetrakis ethylmethylamino hafnium (TEMAH) and tetrakis ethylmethylamino zirconium (TEMAZ), etc., are used for manufacturing a semiconductor. A process, which uses the organic metal precursors including TEMAH, TEMAZ, etc., is performed at a temperature less than about 300° C. in view of deposition characteristics and particle characteristics. However, a thin layer formed at a temperature less than about 300° C. has a significant amount of residual carbon components. Furthermore, the crystallinity of the thin layer is low so that the thin layer is crystallized in a subsequent process. Thus, the thin layer formed from the above-mentioned organic metal precursor may not optimize capacitance characteristics and leakage current characteristics.

### SUMMARY OF THE INVENTION

Example embodiments of the present invention provide a method of forming a thing layer including a metal oxide that is capable of improving capacitance characteristics and leakage current characteristics and capable of being crystallized in a vapor deposition process.

Example embodiments of the present invention also provide a method of manufacturing a gate structure including a gate insulation layer having the above-mentioned metal oxide.

Example embodiments of the present invention also provide a method of manufacturing a capacitor including a dielectric layer having the above-mentioned metal oxide.

A method of manufacturing a thin layer can be provided. The method comprises providing an organic metal precursor to a substrate. The organic metal precursor in one embodiment has a vapor pressure of from about 0.5 Torr up to about 6 Torr at a temperature of from about 65° C. up to about 95° C. The organic metal precursor in another embodiment can have a chemical structure represented by the following Chemical Formula 1:

A-MO—R]₃ <Chemical Formula 1>

wherein A can comprise a cyclic compound or a heterocyclic compound, having more than 4 carbon atoms, and M can comprise titanium (Ti), zirconium (Zr) or hafnium (Hf), and R can comprise an alkyl group having 1 to 5 carbon atoms. In one embodiment, the organic metal precursor has a chemical structure which is represented by the following Chemical Formula 2 or Chemical Formula 3:

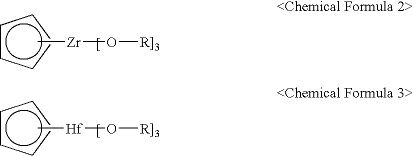

wherein R can comprise an alkyl group having 2 to 4 carbon atoms.

An oxidant in a further embodiment can be provided including an oxygen atom to the substrate to oxidize the organic metal precursor. In still a further embodiment, the organic metal precursor is reacted with the oxidant to form a thin layer including a metal oxide on the substrate.

The organic metal precursor in an embodiment herein can be formed by heating a liquid organic metal precursor at a temperature of from about 75° C. up to about 90° C. In still a further embodiment, the organic metal precursor in a gas phase can have a saturation vapor pressure of from about 1.1 Torr up to about 4 Torr. In another embodiment, the organic metal precursor can be provided onto the substrate using a liquid delivery system. In still another embodiment, the organic metal precursor is vaporized at a temperature of from about 100° C. up to about 150° C. in the liquid delivery system.

The method can comprise the steps of purging the substrate by using a purge gas after providing the organic metal precursor to the substrate. It can also provide the step of purging the substrate by using a purge gas after providing the oxidant to the substrate.

In one embodiment, the thin layer is formed under a pressure of from about 0.5 Torr up to about 3.0 Torr, which can be conducted at a temperature of from about 350° C. up to about 450° C. In another embodiment, the metal oxide of the thin layer is crystallized while the thin layer including the metal oxide can be formed. In still another embodiment, the metal oxide of the thin layer can be crystallized while the thin layer including the metal oxide is formed.

In a further embodiment, a further method of manufacturing a thin layer can comprise (step a) and the (step b) chemically adhering a first portion of a first reactant having the chemical structure of Chemical Formula 1 to the substrate and physically adhering a second portion of the first reactant to the substrate. Then, an oxidant including an oxygen atom to the substrate can be provided (step c). The first portion of the first reactant can be chemically reacted with the oxidant to form a first solid material including a metal oxide on the substrate (step d). A second reactant can be provided, including an organic aluminum precursor, to the first solid material (step e), and a first portion of the second reactant is chemically adhered to the first solid material and physically adhered to a second portion of the first reactant to the first solid material (step f). An oxidant can be provided to the first solid material (step g). The first portion of the second reactant then chemically reacted with the oxidant to form a second solid material, including an aluminum oxide, on the first solid material (step h).

In one embodiment, a first cycle comprising steps a) to d), and a second cycle including steps e) to h) are respectively repeated at least once. In another embodiment, a cycle comprising steps a) to h) is repeated at least once.

The further method can also comprise removing the second portion of the first reactant, which is physisorbed to the substrate. Next, a remaining unreacted portion of the oxidant is removed after providing the oxidant to the substrate. The second portion of the second reactant, which is physisorbed to the first solid material, can also be removed. Then, a remaining unreacted portion of the oxidant after providing the oxidant to the first solid material can be removed.

In a method of manufacturing a gate structure, the method can comprise, in one embodiment, providing an organic metal precursor having a chemical structure represented by Chemical Formula 1, and further providing an oxidant including an oxygen atom to the substrate to oxidize the organic metal precursor. The organic metal precursor is reacted with the oxidant to form a gate insulation layer including a metal oxide on the substrate. A conductive layer is formed on the gate insulation layer. The conductive layer and the gate insulation layer are then sequentially patterned to form a gate structure including a gate conductive pattern and a gate insulation pattern.

In a method of manufacturing a capacitor, the method can comprise forming a lower electrode on a substrate, and providing an organic metal precursor to the substrate having the lower electrode, having a chemical structure represented by Chemical Formula 1. An oxidant including an oxygen atom is to the substrate to oxidize the organic metal precursor. The organic metal precursor is reacted with the oxidant to form a dielectric layer including a metal oxide on the lower electrode. Then, an upper electrode is formed on the dielectric layer.

According to example embodiments of the present invention, an organic metal precursor that may be used for manufacturing a thin layer including a metal oxide has a high saturation vapor pressure and a high reactivity with an oxidant when compared to conventionally used tetrakis ethylmethylamino hafnium (TEMAH), tetrakis ethylmethylamino zirconium (TEMAZ), etc. Furthermore, the organic metal precursor may not be rapidly decomposed by heat at a temperature of from about 350° C. up to about 450° C. Thus, the organic metal precursor can be employed using an ALD method. Furthermore, the organic metal precursor may form a thin layer including a metal oxide at a temperature of from about 350° C. up to about 450° C. Thus, the thin layer can have less carbon. Furthermore, in one embodiment, the thin layer may improve leakage current characteristics and a dielectric constant since the metal oxide is crystallized while the thin layer is formed. Thus, the thin layer can be used for a gate insulation layer of a gate structure, a dielectric layer of a capacitor, a dielectric layer of a flash memory device, etc.

### BRIEF DESCRIPTION OF THE DRAWINGS

The above and other features and advantages of the present invention will become more apparent by describing in detailed example embodiments thereof with reference to the accompanying drawings, in which:

FIGS. 1, 2, 3, 4 and 5 are cross-sectional views illustrating a method of manufacturing a thin layer according to an example embodiment of the present invention;

FIG. 6 is a flowchart illustrating a method of manufacturing a thin layer according to an example embodiment of the present invention;

FIGS. 7, 8, 9 and 10 are cross-sectional views illustrating a method of manufacturing a gate structure according to an example embodiment of the present invention;

FIGS. 11, 12, 13 and 14 are cross-sectional views illustrating a method of manufacturing a capacitor according to an example embodiment of the present invention;

FIG. 15 is a graph illustrating variations of saturation vapor pressures of cyclopentadienyl zirconium triisopropoxide (CpZr(OiPr)₃) and tetrakis ethylmethylamino zirconium (TEMAZ);

FIG. 16 is a graph illustrating results obtained from thermo gravimetric analysis (TGA) of CpZr(OiPr)₃ and TEMAZ;

FIG. 17 is graph illustrating a thickness variation of a thin layer depending on a temperature, the thin layer being formed through a deposition method respectively using CpZr(OiPr)₃ and TEMAZ;

FIG. 18 is an X-ray diffraction (XRD) analysis graph of a thin layer formed by using TEMAZ;

FIG. 19 an X-ray diffraction (XRD) analysis graph of a thin layer formed by using CpZr(OiPr)₃;

FIG. 20 is a graph illustrating leakage current characteristics of capacitors including zirconium layers formed by using CpZr(OiPr)₃ and TEMAZ; and

FIG. 21 a graph illustrating a step coverage of zirconium layers formed by using CpZr(OiPr)₃ and TEMAZ.

### DESCRIPTION OF THE EMBODIMENTS

The present invention is described more fully hereinafter with reference to the accompanying drawings, in which example embodiments of the present invention are shown. The present invention may, however, be embodied in many different forms and should not be construed as limited to the example embodiments set forth herein. Rather, these embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the present invention are described herein with reference to cross-section illustrations that are schematic illustrations of idealized embodiments (and intermediate structures) of the present invention. As such, variations from the shapes of the illustrations accordingly, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### Method of Manufacturing a Thin Layer—Example Embodiment 1

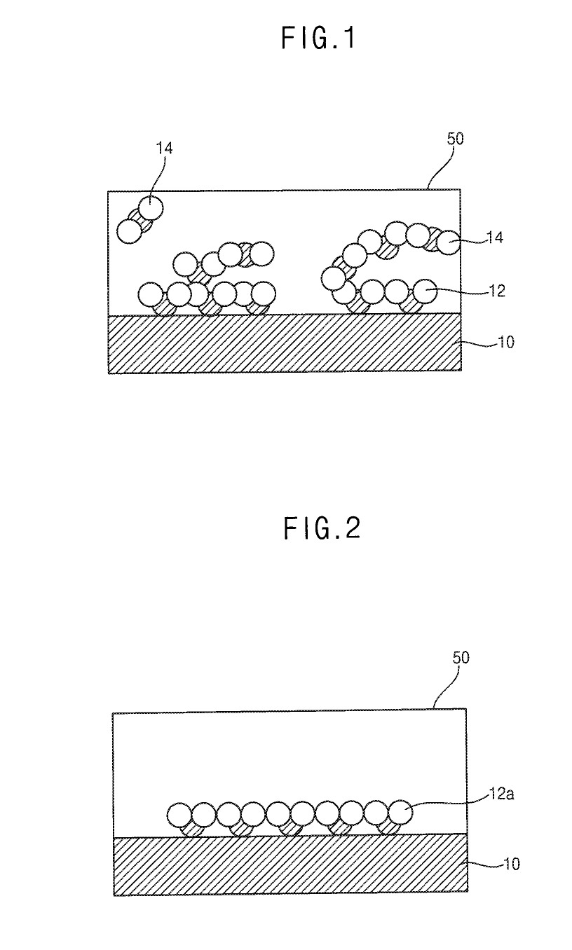

FIGS. 1, 2, 3, 4 and 5 are cross-sectional views illustrating a method of manufacturing a thin layer according to an example embodiment of the present invention.

Referring to FIG. 1, a substrate 10 is disposed in a process chamber 50 for forming a thin layer. When an internal temperature of the process chamber 50 is less than about 300° C., a reactivity of an organic metal precursor in a gas phase may be reduced in a following process, and carbon impurities in the thin layer may be increased. When an internal temperature of the process chamber 50 is more than about 500° C., a thin layer formed on the substrate 10 may have characteristics of chemical vapor deposition. Thus, in one embodiment, an internal temperature of the process chamber 50 may be from about 300° C. up to about 500° C., and in another embodiment from about 350° C. up to about 450° C. In a further embodiment, an internal temperature of the process chamber 50 may be about 400° C. An atomic layer deposition (ALD) method may be readily performed at a temperature of about 400° C., and a thin layer may have less carbon components at the temperature of about 400° C.

When an internal pressure of the process chamber 50 is less than about 0.5 Torr, a reactivity of an organic metal precursor having a gas phase may be reduced in a following process. When an internal pressure of the process chamber 50 is more than about 3.0 Torr, processes for forming a thin layer including a metal oxide may not be easily controlled. Thus, in one embodiment, an internal pressure of the process chamber 50 may be from about 0.5 Torr up to about 3.0 Torr, and in another embodiment from about 0.5 Torr up to about 2.0 Torr. In a further embodiment, an internal pressure of the process chamber 50 may be about 1.0 Torr. An ALD method may be readily performed under a pressure of about 1.0 Torr,

Thereafter, an organic metal precursor can be provided onto the substrate 10. For example, an organic metal precursor represented by the following Chemical Formula 1 may provided into the process chamber 50 having a predetermined temperature and a predetermined pressure. The organic metal precursor may be provided into the process chamber 50 by using a liquid delivery system (LDS). For example, in one embodiment, the organic metal precursor may be provided on the substrate for from about 0.5 up to about 5 seconds. In another embodiment, the organic metal precursor may be vaporized by the LDS at a temperature of about from about 100° C. up to about 150° C., and may be provided into the process chamber 50 for about 1 second.

Accordingly, a first portion 12 of the organic metal precursor is chemically adhered to the substrate 10. A second portion 14 of the organic metal precursor, which corresponds to the remaining portion of the organic metal precursor except for the first portion 12, in one embodiment, may be physisorbed to the first portion 12, or in another embodiment, may be disposed in the process chamber 50 without being adhered to the first portion 12. The portion of the organic metal precursor chemically adhered to the substrate 10 may be decomposed by heat in the process chamber 50. Thus, a portion of a ligand of organic metal, which is combined with the metal precursor, may be separated from the metal with the metal being chemically adhered to the substrate 10.

In one embodiment, the organic metal precursor can be a compound represented by the following:

A-MO—R]₃ <Chemical Formula 1>

In Chemical Formula 1, A represents a cyclic compound or a heterocyclic compound, having carbon atoms of more than 4, and M represents titanium (Ti), zirconium (Zr) or hafnium (Hf), and R represents an alkyl group having carbon atoms of 1 to 5, for example, a methyl group, an ethyl group, a propyl group, an isopropyl group, a tert-butyl group, etc.

The organic metal precursor, in another embodiment, may be represented by the following Chemical Formula 2 or Chemical Formula 3. In still another embodiment, the organic metal precursor may be represented by the following Chemical Formula 4 or Chemical Formula 5.

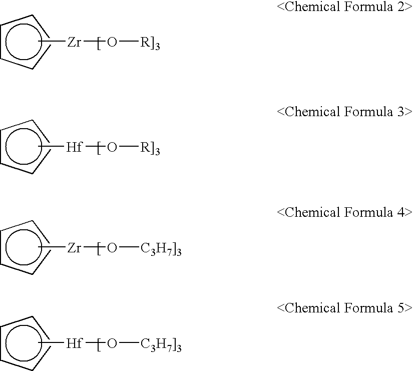

In Chemical Formulas 2 and 3, R can independently represent an alkyl group having carbon atoms of 2 to 4. The organic metal precursors represented by Chemical Formulas 2 to 5 are in a liquid phase at a room temperature, and in a gas phase at a temperature of from about 65° C. up to about 95° C. When the organic metal precursors are vaporized, as for example in a canister, a saturation vapor pressure may be from about 0.5 Torr up to about 6 Torr.

In an embodiment herein, the organic metal precursor in a liquid phase may be introduced into a canister and may be heated to a temperature of from about 65° C. up to about 95° C. so as to generate an inert gas, more particularly in the form of gas bubbles. Accordingly, the organic metal precursor in a gas phase may be generated in the canister. The organic metal precursor in a gas phase may be generated until a vapor pressure of the organic metal precursor in a gas phase achieves a saturation vapor pressure.

In one embodiment, the organic metal precursor in a gas phase may have a saturation vapor pressure of from about 0.5 Torr up to about 3 Torr when heated at a temperature of from about 65° C. up to about 75° C., in another embodiment, the organic metal precursor in a gas phase may have a saturation vapor pressure of from about 3 Torr up to about 6 Torr when heated at a temperature of from about 85° C. up to about 95° C. The organic metal precursor has a relatively high saturation vapor pressure and a relatively high reactivity with an oxidant when compared to a conventional organic metal precursor such as tetrakis ethylmethylamino hafnium (TEMAH), tetrakis ethylmethylamino zirconium (TEMAZ), etc. The organic metal precursor may include a hafnium precursor and/or a zirconium precursor.

Since the organic metal precursor has a relatively high saturation vapor pressure, the organic metal precursor in a gas phase may be readily generated, and the time for providing the organic metal precursor into the process chamber may be reduced. Furthermore, less carrier gas can be provided into the process chamber if the organic metal precursor is in a gas phase. Thus, the total volume of an inlet gas, including the carrier gas and the organic metal precursor, in a gas phase, may be reduced.

Furthermore, the organic metal precursor may be useful for an ALD method for forming a metal oxide layer since an organic ligand of the organic metal precursor may not be rapidly decomposed at a temperature more than about 300° C. Moreover, the metal oxide layer formed at a temperature more than about 300° C. has relatively small impurities such as carbon, and the metal oxide layer is crystallized so that characteristics of the metal oxide layer are not changed through a following process. Thus, in one embodiment, a temperature for manufacturing a thin layer by using the organic metal precursor may be from about 300° C. to about 500° C., and in another embodiment, may be from about 350° C. up to about 450° C.

Thus, the deposition process using the organic metal precursor, which may be represented by the above-mentioned chemical formulas, may form a thin layer that has a relatively high dielectric constant compared to a thin layer formed using a conventional method. These processes have improved leakage current characteristics. Furthermore, the thin layer may be crystallized.

The zirconium precursor represented by Chemical Formula 3 will be used as an example of the organic metal precursor. Referring to FIG. 2, an inert gas, such as a purge gas, is provided in the process chamber 50. Examples of the inert gas may include an argon gas, a nitrogen gas and the like. In one embodiment, the purge gas may be provided for from about 1 up to about 30 seconds. In another embodiment, the purge gas may be provided for about 30 seconds.

When the purge gas is provided into the process chamber 50, the second portion 14 floats in the process chamber 50, becomes physisorbed to the first portion 12 of the zirconium precursor and may be removed. Thus, the zirconium precursors 12a of the first portion 12 can be chemically adhered to the substrate 10 and remain on the substrate 10.

Alternatively, when the process chamber 50 is maintained under vacuum for from about 1 up to about 30 seconds instead of providing the purge gas, the second portion 14 can float in the process chamber 50 and become physisorbed to the first portion 12 of the zirconium precursor and may be removed. Furthermore, when the process chamber 50 is maintained under vacuum having the purge gas provided therein, the second portion 14 can float in the process chamber 50 and become physisorbed to the first portion 12 of the zirconium precursor and may be removed.

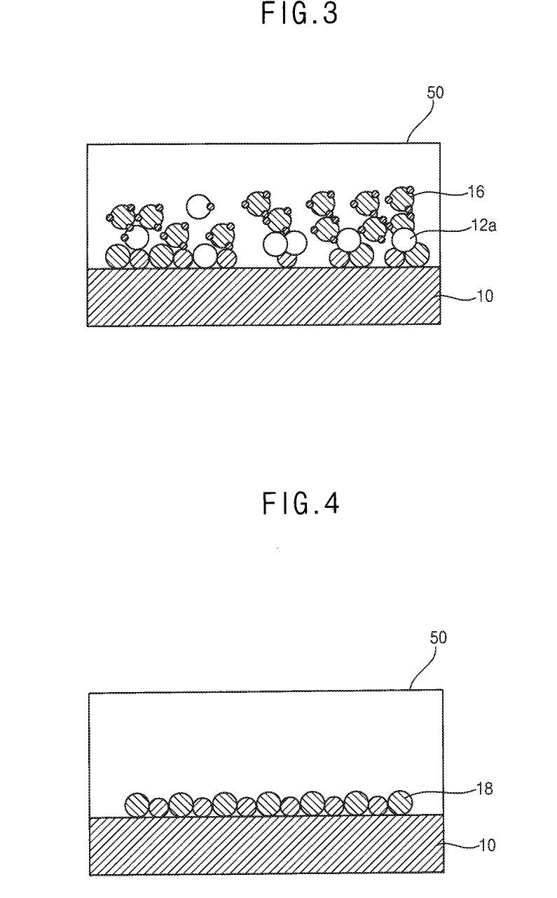

Referring to FIG. 3, an oxidant 16 including an oxygen atom is provided into the process chamber 50. Examples of the oxidant may include an ozone gas, an oxygen gas, a water vapor, an oxygen plasma, a remote oxygen plasma and the like. Theses can be used in combination or alone. For example, the oxidant 16 may be provided for a time period of from about 0.5 up to about 5 seconds. In an example embodiment, an ozone gas employed as the oxidant 16 can be provided for about 2 seconds. When the oxidant 16 is provided into the process chamber 50, the oxidant 16 chemically reacts with the zirconium precursors 12a of the first portion 12 chemically adhering to the substrate 10 to oxidize the zirconium precursors 12a.

Referring to FIG. 4, a purge gas is provided into the process chamber 50. The conditions of providing time and the kind of the purge gas employed can be substantially the same as those of the purge gas described in FIG. 2. The purge gas is provided into the process chamber 50 so that the oxidant 16 that does not react is removed from the process chamber 50. A solid material 18 including zirconium oxide can be formed on the substrate 10.

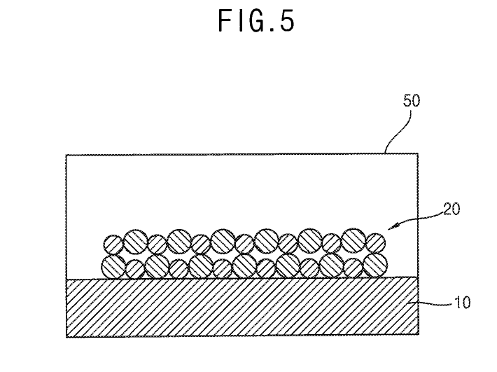

Referring to FIG. 5, the processes described in FIGS. 1 to 4 can be repeated, at least once. Accordingly, a thin layer 20 formed by depositing the solid material 18 is formed on the substrate 10. The thin layer 20 can include a zirconium oxide. The thickness of the thin layer 20 may be controlled depending on the number of replications of the processes.

According to an example embodiment of the present invention, a thin layer including a zirconium oxide or a hafnium oxide may be formed by using a zirconium precursor or a hafnium precursor, both of which have a relatively high saturation vapor pressure. The thin layer may have a relatively a high dielectric constant and an improved leakage current characteristic.

Alternatively, a thin layer may be formed by a chemical vapor deposition method simultaneously providing the zirconium precursor in a gas phase and an oxidant into a process chamber. The procedure can be used instead of an ALD method.

In one embodiment, the zirconium precursor in a gas phase and the oxidant are provided simultaneously on the substrate disposed in the process chamber. Then, the zirconium precursor chemically reacts with the oxidant to generate a zirconium oxide. The zirconium oxide is chemically adhered to a surface of the substrate to generate a solid material. The zirconium oxide is chemically adhered to the solid material for a predetermined time to form a thin layer. The thickness of the thin layer may be controlled depending on the time of the chemical vapor deposition process.

### Method of Manufacturing a Thin Layer—Example Embodiment 2

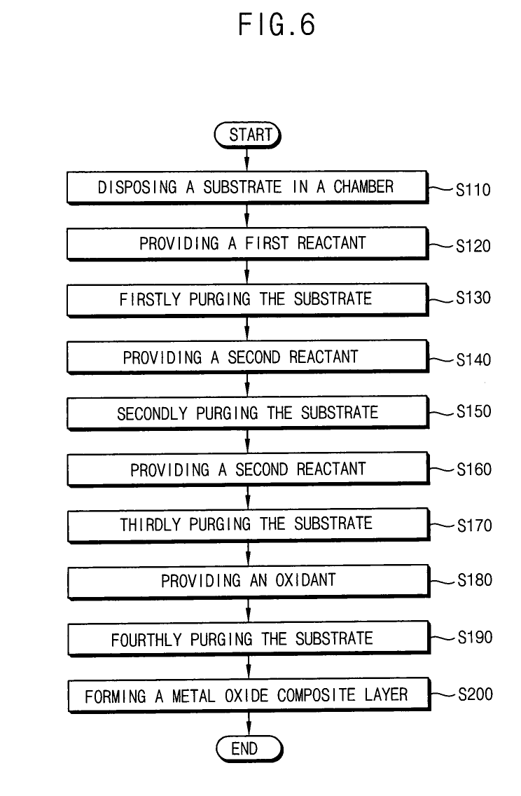

Referring to FIG. 6, a substrate is disposed in a chamber (Step S110). In one embodiment, the temperature of the substrate may be from about 300° C. up to about 500° C. In another embodiment, the temperature of the substrate may be from about 350° C. up to about 450° C., and may be more preferably about 400° C.

Thereafter, a first reactant that is an organic metal precursor may be provided to the substrate (Step S120). Examples of the first reactant may include at least one of the organic metal precursors represented by the above-described Chemical Formulas 2 to 5. Thus, any further explanation of the organic metal precursor will be omitted. The organic metal precursors may include a zirconium precursor, a hafnium precursor and the like. The zirconium precursor may be represented by the above-described Chemical Formula 4, and the hafnium precursor may be represented by the above-described Chemical Formula 5.

In one embodiment, the first reactant may be provided onto the substrate for a period of time of from about 0.5 up to about 3 seconds. In another embodiment, the first reactant may be provided on the substrate for up to about 1 second, and in still another embodiment through an LDS. When the first reactant is provided on the substrate, a first portion of the organic metal precursor is chemically adhered to the substrate, and a second portion of the organic metal precursor is physisorbed to the substrate.

Thereafter, a purge gas is provided onto the substrate to first purge the substrate (Step S130). The purge gas may include an argon gas, and may be provided onto the substrate for from about 0.5 up to about 3 seconds. In an embodiment herein, the argon gas may be provided onto the substrate for a period of time up to about 1 second. When the argon gas is provided onto the substrate, the second portion of the organic metal precursor, which is physisorbed to the substrate, may be removed. In one embodiment, a carbon hydrogen radical of the organic metal precursor may be separated from the substrate by the argon gas. However, even if the argon gas is provided onto the substrate, zirconium in the organic metal precursor may be maintained by chemically adhering it to the substrate. In another embodiment, the chamber may be maintained under vacuum for from about 2 up to about 3 seconds so that a carbon hydrogen radical of the organic metal precursor may be separated from the substrate.

Thereafter, an oxidant including an oxygen atom can be provided onto the substrate (Step S140). Examples of the oxidant may include an ozone gas, an oxygen gas, a water vapor, a methanol gas, an ethanol gas and the like. Theses can be used in a combination or alone. In an example embodiment, an ozone gas may be used as the oxidant. In one embodiment, this ozone gas as the oxidant may be provided onto the substrate for from about 1 to up to about 5 seconds. In a further embodiment, the ozone gas may be provided on the substrate for about 3 seconds. When the oxidant is provided onto the substrate, zirconium chemically adhered to the substrate may be oxidized. Thus, a first solid material including a zirconium oxide can be formed on the substrate.

Thereafter, the substrate is purged by using an argon gas (Step S150). The argon gas may be used for purging the substrate, and may be provided onto the substrate for from about 1 up to about 5 seconds. In a further embodiment, the argon gas may be provided on the substrate for about 3 seconds. When the argon gas is provided onto the substrate, remaining oxidant in the chamber may be removed.

Accordingly, a first solid material including a zirconium oxide can be formed on the substrate. When providing an organic metal precursor, an argon gas is first provided. Then an oxidant is introduced and an argon gas is again provided. The first solid material can include zirconium oxide so that a zirconium oxide layer can be formed, in a solid thin layer, having a desired thickness.

Thereafter, a second reactant is provided on the first material (Step S160). The second reactant may include an aluminum precursor. Examples of the aluminum precursor may include trimethyl aluminum (TMA) precursor, triethyl aluminum (TEA) precursor, triisobutyl aluminum precursor and the like. In one embodiment, the second reactant may be provided on the first material for about 1 second. When TMA is used as the aluminum precursor on the first solid material, a first portion of the aluminum precursor may be chemically adhered to the first solid material, and a second portion of the aluminum precursor may be physisorbed to the first solid material.

Thereafter, the substrate can be purged by using an inert gas such as an argon gas (Step S170). The inert gas may be used for purging the substrate, and may be provided on the first solid material for up to about 1 second. When the argon gas is provided on the first solid material, the second portion of the aluminum precursor, which is physisorbed to the first solid material, may be removed.

Thereafter, an oxidant is provided on the first solid material, to which the first portion of the aluminum precursor is adhered (Step S180). The oxidant may be substantially the same as the oxidant described in Step S140. For example, an ozone gas may be used for the oxidant, and the ozone gas may be provided on the first solid material for about 3 seconds. When the oxidant is provided on the first solid material, aluminum adhered to the first solid material may be oxidized. Thus, a second solid material including an aluminum oxide is formed on the first solid material.

Thereafter, the substrate is purged by using an inert gas such as argon gas (Step S190). The inert gas may be used for purging the substrate, and may be provided on the second solid material for about 3 seconds. When the inert gas is provided on the second solid material, a remaining oxidant in the process chamber may be removed.

Accordingly, the second solid material 180 including an aluminum oxide is formed on the first solid material. When providing an aluminum precursor, the steps of providing an inert gas, providing an oxidant, and then again providing an argon gas are repeated. The second solid material including an aluminum oxide may be formed so that an aluminum oxide layer, that is a solid thin layer including an aluminum oxide having a desired thickness, may be formed.

When the quantity of reactants used in producing the first solid material including a zirconium oxide formed by using a zirconium precursor, and the quantity of reactants used in producing the second solid material including an aluminum oxide by using an aluminum precursor are each controlled, a metal oxide composite layer that includes a zirconium aluminum oxide having a desired ratio of aluminum and zirconium is formed (Step S200).

Alternatively, when the quantity of reactants used in producing the first solid material including a hafnium oxide formed by using a hafnium precursor, and the quantity of reactants used in producing the second solid material including an aluminum oxide by using an aluminum precursor are each controlled, a metal oxide composite layer that includes a hafnium aluminum oxide having a desired ratio of aluminum and hafnium is formed.

Method of Manufacturing a Gate Structure

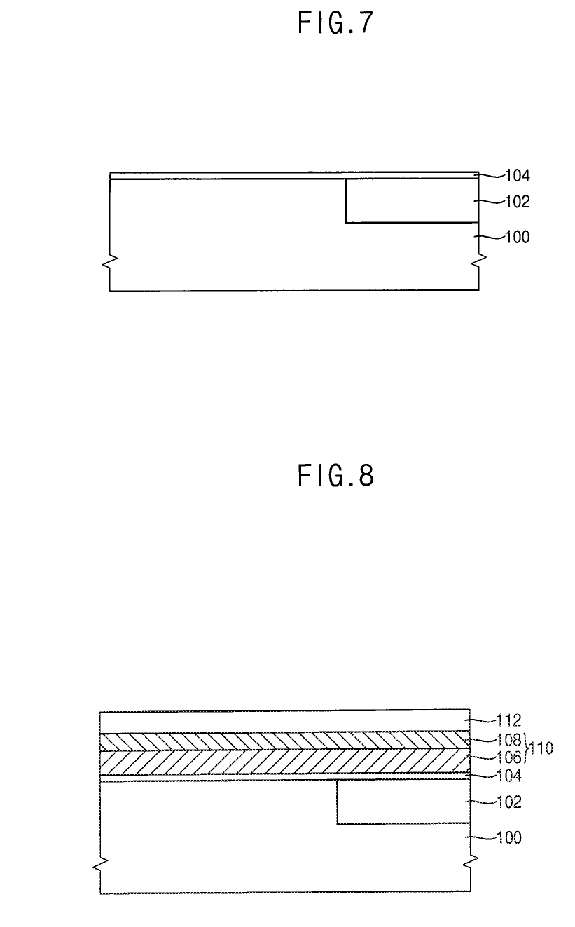

FIGS. 7, 8, 9 and 10 are cross-sectional views illustrating a method of manufacturing a gate structure according to an example embodiment of the present invention.

Referring to FIG. 7, an isolation process is performed to divide a substrate 100 into an active region (not shown) and a field region 102. Examples of the substrate 100 may include a silicon-on-insulator (SOI) substrate, etc.

Thereafter, a gate insulation layer 104 is formed on the substrate 100. The gate insulation layer 104 can reduce the leakage current generating between a gate electrode and a channel while maintaining a thin equivalence thickness.

Thus, a thin layer including a metal oxide can be formed as the gate insulation layer 104 in an example embodiment. For example, the thin layer may include a hafnium oxide and/or a zirconium oxide and may be formed using an ALD method according to Example Embodiment 1 as described above. Alternatively, the thin layer may include a zirconium aluminum oxide and may be formed using an ALD method according to Example Embodiment 2 as described above.

An organic metal precursor used for the ALD method may be represented by the following Chemical Formula 1.

A-MO—R]₃ <Chemical Formula 1>

In Chemical Formula 1, A represents a cyclic compound or a heterocyclic compound, having more than 4 carbon atoms, and M represents titanium (Ti), zirconium (Zr) or hafnium (Hf), and R represents an alkyl group having 1 to 5 carbon atoms, in an embodiment herein, a methyl group, an ethyl group, a propyl group, an isopropyl group, a tert-butyl group, etc.

In one embodiment, the organic metal precursor may be represented by the structural formulas Chemical Formula 2-5 described above. In another embodiment, Chemical Formulas 2 and 3 comprise R which represents an alkyl group having 2 to 4 carbon atoms.

The organic metal precursors represented by Chemical Formulas 1 to 4 above is in a liquid phase at a room temperature, and in a gas phase at a temperature of from about 65° C. up to about 95° C. When the organic metal precursors are vaporized, as for example in a canister, a saturation vapor pressure may be from about 0.5 Torr up to about 6 Torr.

Since the method of manufacturing a thin layer is described above, any further explanation will be omitted.

In an example embodiment, the zirconium precursor may be used in an ALD method to form the gate insulation layer 104 including a zirconium oxide. Furthermore, a silicon oxide layer (not shown), having a thickness of about 5 Å, may be further formed on the gate insulation layer 104. The silicon oxide layer may be formed in situ after the gate insulation layer 104 including a hafnium oxide is formed.

Referring to FIG. 8, a gate conductive layer 110 is formed on the gate insulation layer 104. The gate conductive layer 110 has a multilayered structure including a polysilicon layer 106 and a metal silicide layer 108 such as a tungsten silicide layer. Furthermore, a capping insulation layer 112 including a silicon oxide may be formed on the gate conductive layer 110.

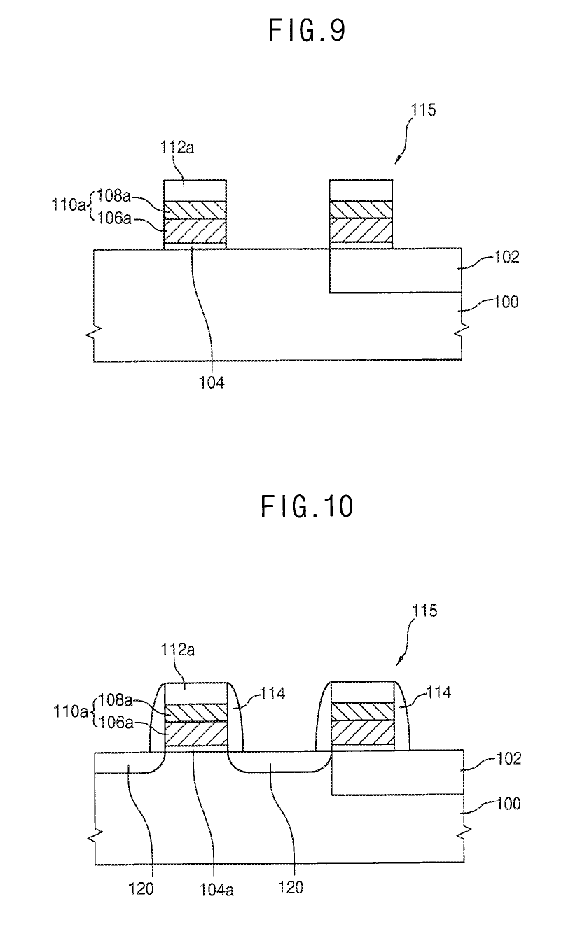

Referring to FIG. 9, the capping insulation layer 112, the gate conductive layer 110 and the gate insulation layer 104, which are formed on the substrate 100, are sequentially patterned. Accordingly, a gate structure 115 including a gate insulation pattern 104a, a gate conductive pattern 110a and a capping insulation pattern 112a is formed on the substrate 100. The capping insulation layer 112, the gate conductive layer 110 and the gate insulation layer 104 may be formed through a photolithography process.

Referring to FIG. 10, a source/drain area 120 is formed at an upper portion of the substrate 110, which is adjacent to the gate structure 115. The source/drain area 120 may be formed before the gate insulation layer 104 is formed or after a spacer 114 is formed on the gate structure 115. The gate insulation pattern including a hafnium oxide and/or a zirconium oxide, which have a relatively high dielectric constant, may efficiently reduce the leakage current generating between a gate electrode and a channel while maintaining a thin equivalence thickness. Furthermore, since the gate insulation pattern is formed on a substrate at a temperature of more than about 400° C., the gate insulation pattern may have fewer impurities such as carbon and may be crystallized through a deposition process.

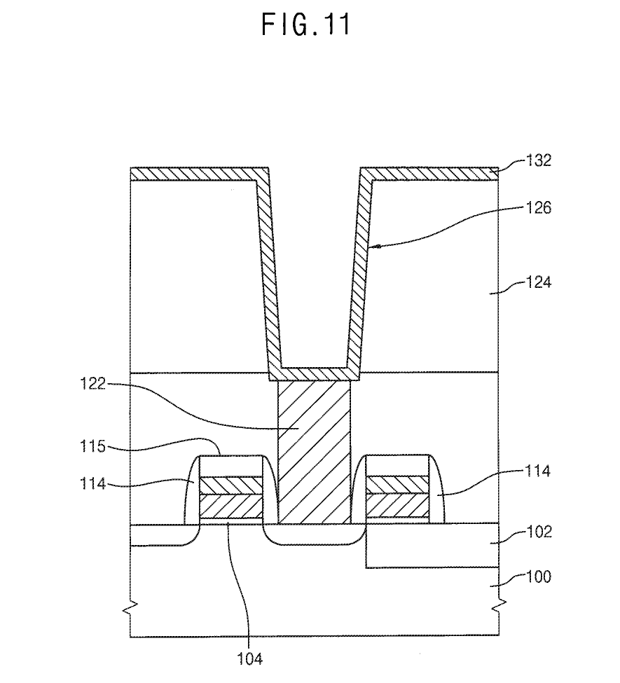

FIGS. 11, 12, 13 and 14 are cross-sectional views illustrating a method of manufacturing a capacitor according to an example embodiment of the present invention. Referring to FIG. 11, after a substrate 130 is prepared that has an insulating interlayer 124 having a contact hole 126 exposing a contact plug 122, a conductive layer 132 for a lower electrode, which is electrically connected to the contact plug 122, is formed. When the substrate 130 is used for a dynamic random access memory (DRAM), the substrate 130 may have a semiconductor structure such as a gate structure 115 including a spacer 114, a beat line (not shown), the contact plug 122, etc.

The conductive layer 132 for a lower electrode is continuously formed on a bottom and a side surface of the contact hole 126. Examples of a material that may be used for the conductive layer 132 may include polysilicon, titanium nitride, tantalum nitride, tungsten nitride, ruthenium and the like. These materials can be used in a combination or alone.

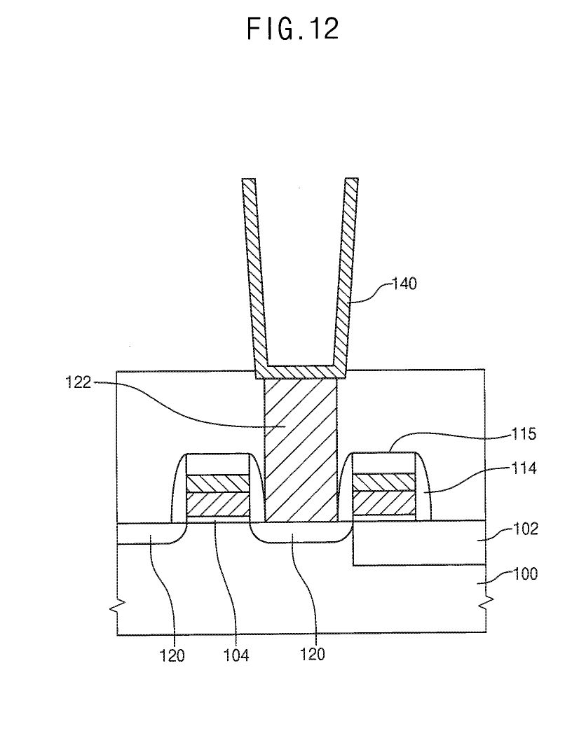

Referring to FIG. 12, a lower electrode 140 electrically connected to the contact plug 122 is formed. For example, a sacrificial layer (not shown) may be formed on the substrate having conductive layer. Thereafter, the sacrificial layer may be removed until a surface of the conductive layer is exposed. Thereafter, the conductive layer formed on the insulating interlayer is removed so that the lower electrode is formed on the bottom and the side surface of the contact hole 126. Thereafter, the sacrificial layer remaining in the contact hole 126 and the insulating interlayer may be entirely removed so that the lower electrode 140 is completely formed. For example, the lower electrode 140 may have a cylindrical shape having a width of an entrance portion, which is greater than that of a bottom.

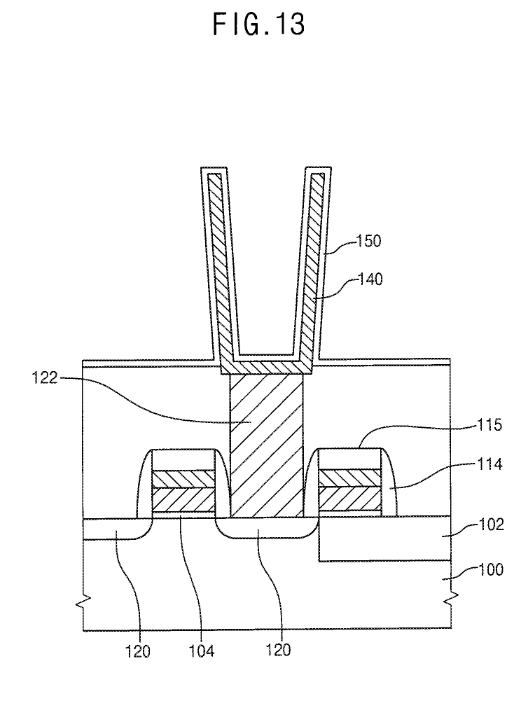

Referring to FIG. 13, a dielectric layer 150 is formed on a surface of the lower electrode 140. The dielectric layer 150 can efficiently reduce a leakage current generating between the lower electrode 140 and an upper electrode while maintaining a thin equivalence thickness and while having a relatively high dielectric constant. Thus, a thin layer including a metal oxide is used for the dielectric layer 150 in an example embodiment.

For example, the thin layer may include a hafnium oxide and/or a zirconium oxide and may be formed through an ALD method according to Example Embodiment 1 as described above. Alternatively, the thin layer may include a zirconium aluminum oxide which may be formed through an ALD method according to Example Embodiment 2 as described above. An organic metal precursor that may be represented by the chemical formulas 1-5, as previously described, may be used for the ALD method.

In an example embodiment, the organic metal precursor can be used for the ALD method to form the dielectric layer 150 including a zirconium oxide on the lower electrode 140. The dielectric layer 150 formed by using the organic metal precursor is crystallized when formed on the substrate. Thus, an additional crystallizing process is not required.

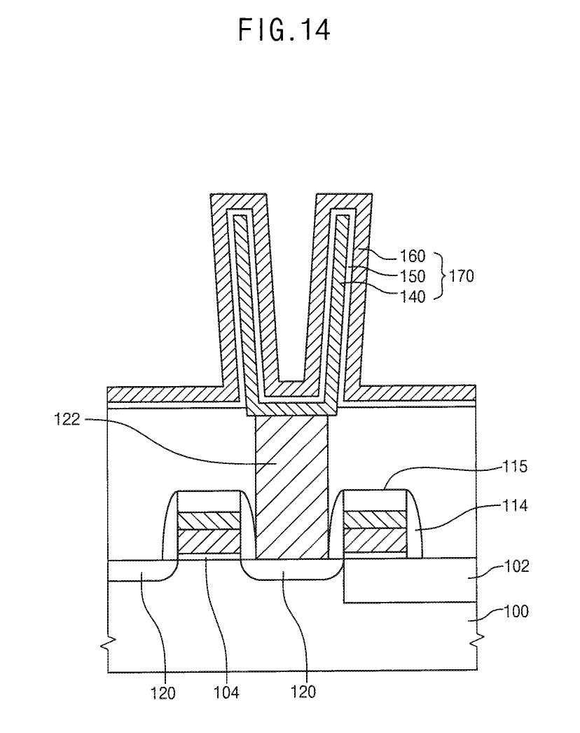

Referring to FIG. 14, an upper electrode 160 is formed on the dielectric layer 150. Examples of a material that may be used for the upper electrode 160 may include polysilicon, titanium nitride, tantalum nitride, tungsten nitride, ruthenium and the like. Theses can be used in a combination or preferably alone.

Accordingly, a capacitor 170 that includes the lower electrode 140, the dielectric layer 150 including a hafnium oxide and the upper electrode 160 is formed on the substrate 130.

In an example embodiment, a solid thin layer including a zirconium oxide and/or a hafnium oxide, which have a relatively high dielectric constant, is used for a dielectric layer. Thus, the dielectric layer may maintain a thin equivalent thickness.

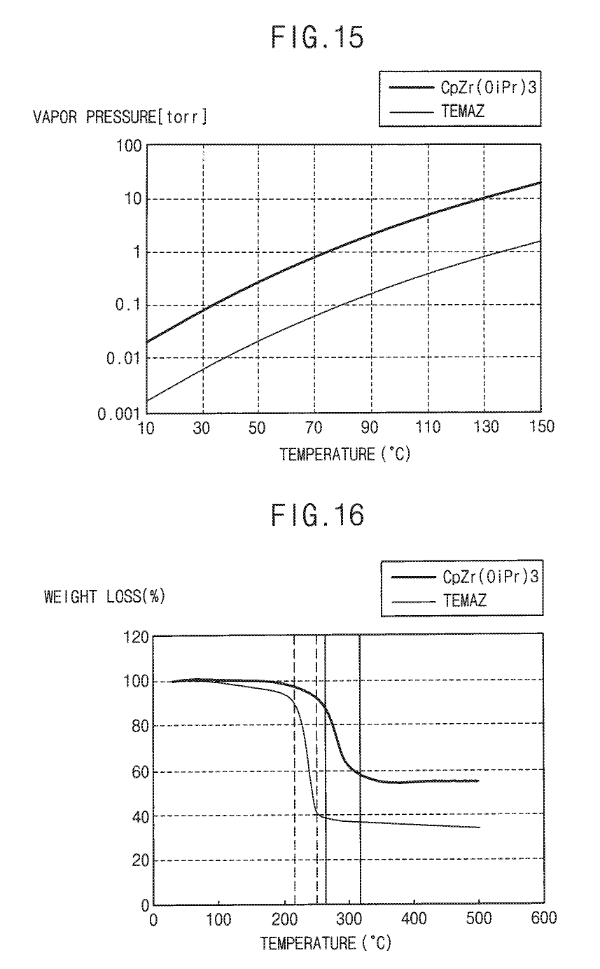

According to an example embodiment, an organic metal precursor and a metal oxide layer formed by using the organic metal precursor will be experimentally compared. Saturation vapor pressures of cyclopentadienyl zirconium triisopropoxide (CpZr(OiPr)₃) and tetrakis ethylmethylamino zirconium (TEMAZ) that may be respectively used as a first zirconium precursor and a second zirconium precursor for manufacturing a thin layer were measured at various temperatures. Particularly, each of the first and second zirconium precursors were introduced into a canister having a volume of about 10 L, and then heated so that they are vaporized. The saturation vapor pressures of the first and second zirconium precursors were measured at a range of temperature. Particularly, the variation of saturation vapor pressures of the first and second zirconium precursors was measured at temperatures ranging from about 30° C. to about 130° C. Thus results obtained are depicted in FIG. 15. In FIG. 15, the saturation vapor pressures of the first and second zirconium precursors are substantially the same as the inner pressure of the canister. The first zirconium precursor was the structure represented by Chemical Formula 4.

Referring to FIG. 15, when CpZr(OiPr)₃ was heated at a temperature of about 60° C., a vapor pressure of CpZr(OiPr)₃ was about 0.5 Torr. Thus, it can be noted that an inner pressure of the canister was about 0.5 Torr. Furthermore, when CpZr(OiPr)₃ was heated at a temperature of about 100° C., a vapor pressure of CpZr(OiPr)₃ was about 6 Torr. Thus, it can be noted that an inner pressure of the canister was about 6 Torr.

However, when TEMAZ which is conventionally used was heated at a temperature of about 60° C., a vapor pressure TEMAZ of was about 0.05 Torr. Thus, it can be noted that an inner pressure of the canister was about 0.05 Torr. Furthermore, when TEMAZ was heated at a temperature of about 100° C., a vapor pressure of TEMAZ was about 0.6 Torr. Thus, it can be noted that an inner pressure of the canister was about 0.6 Torr. Therefore, it can be noted that a vapor pressure of CpZr(OiPr)₃ is about 10 times greater than that of TEMAZ at the same temperature.

FIG. 16 is a graph illustrating results obtained from thermo gravimetric analysis (TGA) of CpZr(OiPr)₃ and TEMAZ. The TGA measures weight variation of a sample depending on temperature, and time lapse with uniformly increasing temperature of the sample or while maintaining the temperature of the sample in order to analyze the weight variation of the sample, which is caused by heat decomposition, sublimation, vaporization, oxidization, etc., through thermogram.

Referring to FIG. 16, while CpZr(OiPr)₃ as a first zirconium precursor and TEMAZ as a second zirconium precursor were heated at a temperature of about 5° C. per a minute, so that a temperature of each of CpZr(OiPr)₃ and TEMAZ was increased from a room temperature to about 500° C., the weight loss of each of CpZr(OiPr)₃ and TEMAZ was measured. The weight of CpZr(OiPr)₃ was critically reduced at a temperature of about 280° C. to about 330° C. In contrast, the weight of TEMAZ was critically reduced at a temperature of about 210° C. to about 250° C. Therefore, it can be noted that zirconium and an organic ligand of CpZr(OiPr)₃ may not be rapidly separated from each other. Therefore, CpZr(OiPr)₃ may be a stable and appropriate organic metal precursor for use in an ALD method.

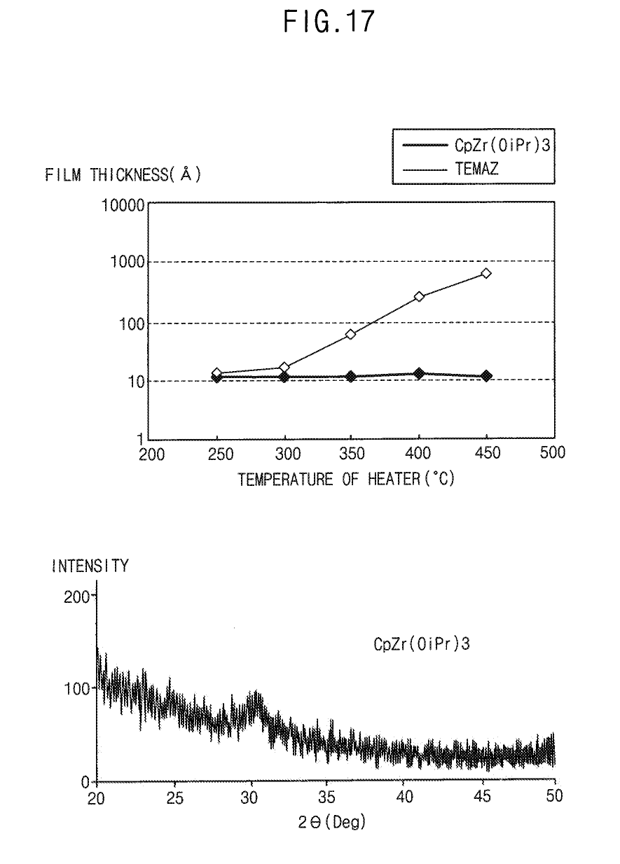

FIG. 17 is graph illustrating a thickness variation of a thin layer depending on a temperature, the thin layer being formed through a deposition method respectively using CpZr(OiPr)₃ and TEMAZ. Referring to FIG. 17, in order to measure a thickness variation of a thin layer formed on a substrate depending on a temperature, a thin layer was formed by performing an ALD method, in which oxygen was substantially excluded from the entire deposition cycle of an ALD method, including providing a precursor, purging, pumping, providing oxygen and oxygen-purging. A thickness of the thin layer formed depending on a deposition temperature was measured. TEMAZ was rapidly decomposed at a temperature greater than about 350° C. so that the thickness of the thin layer formed by using TEMAZ was rapidly increased. In contrast, CpZr(OiPr)₃ was minimally decomposed at a temperature of about 450° C. (which is close to a set-up temperature for an ALD method) so that the thickness of the thin layer formed by using CpZr(OiPr)₃ was uniformly maintained. Thus, it can be noted that CpZr(OiPr)₃ has an improved temperature margin for decomposition as compared to TEMAZ.

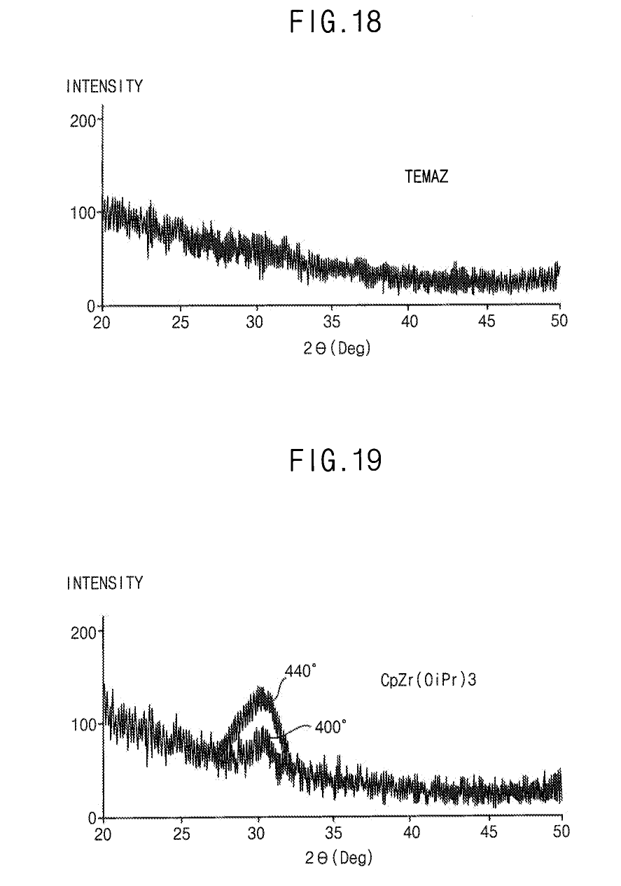

Zirconium oxide layers were formed through an ALD process respectively using CpZr(OiPr)₃ and TEMAZ in a 200 mm single wafer type manufacturing device. The temperature of a heater in the ALD process using CpZr(OiPr)3 was about 360° C. to about 440° C. The temperature of the heater in the ALD process using TEMAZ was about 320° C. Components of the zirconium oxide layers and crystallinities of the zirconium oxide layers were measured according to an X-ray photoelectron spectroscopy (XPS). Thus, the results obtained regarding the components of the zirconium oxide layers are illustrated in the following Table 1, and the results obtained regarding the crystallinities of the zirconium oxide layers are illustrated in FIGS. 18 and 19.

TABLE 1
XPS results for CpZr(OiPr)₃ and TEMAZ

| | | | | | | Concentration |
|---|---|---|---|---|---|---|
| | Heater | Atomic Concentration (%) | | | | Ratio |
| Precursor | Temperature | Zr | C | O | F | O/Zr |
| CpZr(OiPr)₃ | 400° C. | 30.1 | 10.5 | 58.8 | 1.1 | 1.933 |
| TEMAZ | 320° C. | 31.3 | 11.1 | 56.1 | 1.5 | 1.790 |

As a result of measuring a first zirconium layer formed by depositing CpZr(OiPr)₃ at a temperature of about 400° C., the differences between components, which included zirconium (Zr), carbon (C), oxygen (O) and fluorine (F), of the first zirconium layer and components of a second zirconium layer formed by depositing TEMAZ at a temperature of about 320° C. is shown above. The concentration ratio of O/Zr of the first zirconium layer was closer to 2 compared to the concentration ratio of O/Zr of the second zirconium layer. Thus, it can be noted that the concentration ratio of O/Zr of the first zirconium layer is close to an ideal ratio.

FIG. 18 is an X-ray diffraction (XRD) analysis graph of a thin layer formed by using TEMAZ, and FIG. 19 is an XRD analysis graph of a thin layer formed by using CpZr(OiPr)₃.

Referring to FIGS. 18 and 19, as a result of XRD analysis of zirconium layers formed by respectively using CpZr(OiPr)₃ and TEMAZ, the second zirconium layer formed by depositing TEMAZ at a temperature of about 320° C. has a minimum crystallization peak of the 111 direction in a range of 20 to 30. Thus, it can be noted that the second zirconium layer has an amorphous structure. However, the first zirconium layer formed by depositing CpZr(OiPr)₃ at a temperature of about 400° C. had a substantial crystallization peak of the 111 direction in a range of 20 to 30. Thus, it can be noted that the first zirconium layer has a crystalline structure. Furthermore, it can be noted that the crystallinity of the first zirconium layer formed by using CpZr(OiPr)₃ was increased as a temperature was increased.

After zirconium layers through an ALD process respectively using CpZr(OiPr)₃ and TEMAZ were formed, cell capacitors including the zirconium layers were manufactured. A leakage current of each of the cell capacitors is measured. The zirconium layers had a thickness of about 8.8 Å.

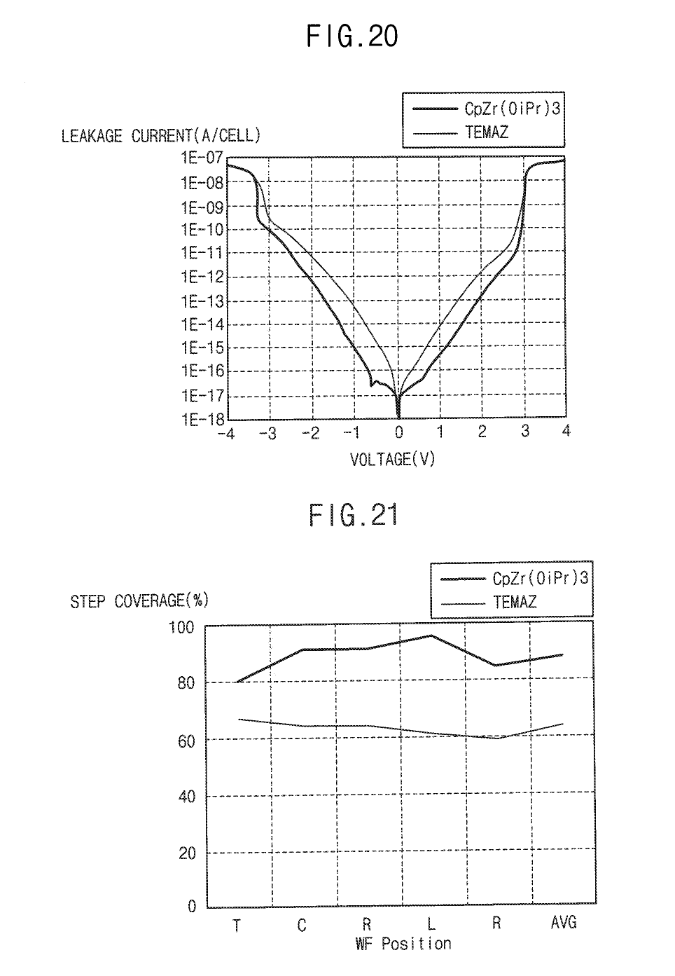

Referring to FIG. 20, a cell capacitor including the zirconium layer formed by using CpZr(OiPr)₃ had a leakage current of about 1.00E-16 A/cm2 at about 0.7 V. Furthermore, the cell capacitor had a leakage current of about 1.00E-15 A/cm2 at about 1.2 V. In contrast, a cell capacitor including the zirconium layer formed by using TEMAZ had a leakage current of about 1.00E-15 A/cm2 at about 0.7 V. Furthermore, the cell capacitor had a leakage current of about 1.00E-14 A/cm2 at about 1.2 V. Thus, it can be noted that the zirconium layer formed by using CpZr(OiPr)₃ may improve leakage current characteristics and cell cap characteristics.

Zirconium layers were formed on a cylindrical structure having an aspect ratio of about 10:1 using an ALD method according to conditions illustrated in the following Table 2. The step coverage of the zirconium layers was measured. The step coverage was represented by a ratio of a thickness of a zirconium layer formed on an upper surface of the cylindrical structure to a thickness of a zirconium layer formed on a bottom surface of a hole of the cylindrical structure.

TABLE 2
Process Conditions

| | Second | Temperature | Temperature of | |
|---|---|---|---|---|
| First Reactant | Reactant | of Chamber | Canister | Carrier Gas |
| CpZr(OiPr)₃ | O₂ | 400° C. | 80° C. | 1000 sccm |
| TEMAZ | O₂ | 320° C. | 80° C. | 1000 sccm |

Referring to FIG. 21, the zirconium layer formed by using CpZr(OiPr)₃ had a step coverage of about 87%. However, the zirconium layer formed by using TEMAZ had a step coverage of only about 64%. Thus, it can be noted that the zirconium layer formed by using CpZr(OiPr)₃ may be used for a capacitor dielectric layer having a cylindrical shape.

According to example embodiments of the present invention, an organic metal precursor that may be used for manufacturing a thin layer including a metal oxide has a high saturation vapor pressure and a high reactivity with an oxidant when compared to conventionally used TEMAH, TEMAZ, etc. Furthermore, the organic metal precursor may not be rapidly decomposed by heat at a temperature of from about 350° C. up to 450° C. Thus, the organic metal precursor should be appropriate for an ALD method.

Furthermore, the organic metal precursor may form a thin layer including a metal oxide at a temperature of from about 350° C. up to about 450° C. Thus, the thin layer may have less carbon. Furthermore, the thin layer may improve leakage current characteristic and a dielectric constant since the metal oxide is crystallized while the thin layer is formed. Accordingly, the thin layer may be used for a gate insulation layer of a gate structure, a dielectric layer of a capacitor, a dielectric layer of a flash memory device, etc.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A method of manufacturing a thin layer comprising:
providing an organic metal precursor to a substrate, the organic metal precursor having a vapor pressure of from about 0.5 Torr up to about 6 Torr at a temperature of from about 65° C. up to about 95° C., and having a chemical structure represented by the following Chemical Formula 1:
A-MO—R]₃ <Chemical Formula 1>
wherein A comprises a cyclic compound or a heterocyclic compound, having more than 4 carbon atoms, and M comprises titanium (Ti), zirconium (Zr) or hafnium (Hf), and R comprises an alkyl group having 1 to 5 carbon atoms;
providing an oxidant including an oxygen atom to the substrate to oxidize the organic metal precursor; and
reacting the organic metal precursor with the oxidant to form a thin layer including a metal oxide on the substrate.

2. The method of claim 1, wherein the organic metal precursor has a chemical structure which is represented by the following Chemical Formula 2 or Chemical Formula 3: 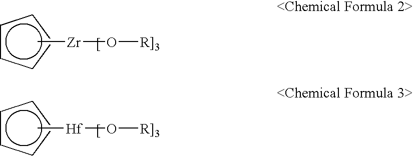
wherein R comprises an alkyl group having 2 to 4 carbon atoms.

3. The method of claim 1, wherein the organic metal precursor is formed by heating a liquid organic metal precursor at a temperature of from about 75° C. up to about 90° C., and the organic metal precursor in a gas phase has a saturation vapor pressure of from about 1.1 Torr up to about 4 Torr.

4. The method of claim 1, wherein the organic metal precursor is provided onto the substrate using a liquid delivery system, and the organic metal precursor is vaporized at a temperature of from about 100° C. up to about 150° C. in the liquid delivery system.

5. The method of claim 1, further comprising:
purging the substrate by using a purge gas after providing the organic metal precursor to the substrate; and
purging the substrate by using a purge gas after providing the oxidant to the substrate.

6. The method of claim 1, wherein the thin layer is formed under a pressure of from about 0.5 Torr up to about 3.0 Torr at a temperature of from about 350° C. up to about 450° C.

7. The method of claim 1, wherein the metal oxide of the thin layer is crystallized while the thin layer including the metal oxide is formed.

8. A method of manufacturing a thin layer comprising:
a) providing a first reactant including an organic metal precursor to a substrate, the organic metal precursor having a vapor pressure of from about 0.5 Torr up to about 6 Torr, at a temperature of from about 65° C. up to about 95° C., and having a chemical structure represented by the following Chemical Formula 1:
A-MO—R]₃ <Chemical Formula 1>
wherein A comprises a cyclic compound or a heterocyclic compound, having more than 4 carbon atoms, and M comprises titanium (Ti), zirconium (Zr) or hafnium (Hf), and R comprises an alkyl group having 1 to 5 carbon atoms;
b) chemically adhering a first portion of the first reactant to the substrate and physically adhering a second portion of the first reactant to the substrate;
c) providing an oxidant including an oxygen atom to the substrate;
d) chemically reacting the first portion of the first reactant with the oxidant to form a first solid material including a metal oxide on the substrate;
e) providing a second reactant including an organic aluminum precursor to the first solid material;
f) chemically adhering a first portion of the second reactant to the first solid material and physically adhering a second portion of the first reactant to the first solid material;
g) providing an oxidant to the first solid material; and
h) chemically reacting the first portion of the second reactant with the oxidant to form a second solid material including an aluminum oxide on the first solid material.

9. The method of claim 8, wherein the organic metal precursor has a chemical structure represented by following Chemical Formula 4 or Chemical Formula 5:

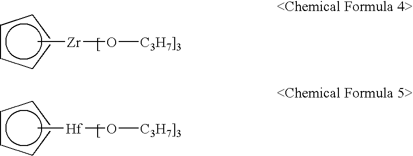

10. The method of claim 8, further comprising:
removing the second portion of the first reactant, which is physisorbed to the substrate;
removing a remaining unreacted portion of the oxidant after providing the oxidant to the substrate;
removing the second portion of the second reactant, which is physisorbed to the first solid material; and
removing a remaining unreacted portion of the oxidant after providing the oxidant to the first solid material.

11. The method of claim 8, wherein a first cycle comprising steps a) to d) and a second cycle including steps e) to h) are respectively repeated at least once.

12. The method of claim 8, wherein a cycle comprising steps a) to h) is repeated at least once.

13. The method of claim 8, wherein the thin layer is formed at a temperature of from about 350° C. up to about 450° C., and the metal oxide of the thin layer is crystallized while the thin layer including the metal oxide is formed.

14. The method of claim 8, wherein the organic metal precursor is formed by heating a liquid organic metal precursor at a temperature of from about 75° C. up to about 90° C., and the organic metal precursor in a gas phase has a saturation vapor pressure of from about 1.1 Torr up to about 4 Torr.

15. The method of claim 8, wherein the organic metal precursor is provided onto the substrate using a liquid delivery system, and the organic metal precursor is vaporized at a temperature of from about 100° C. up to about 150° C. in the liquid delivery system.

16. The method of claim 8, further comprising:
purging the substrate by using a purge gas after providing the organic metal precursor to the substrate; and
purging the substrate by using a purge gas after providing the oxidant to the substrate

17. A method of manufacturing a gate structure, the method comprising:
providing an organic metal precursor to a substrate, the organic metal precursor having a vapor pressure of from about 0.5 Torr up to about 6 Torr at a temperature of from about 65° C. up to about 95° C. and having a chemical structure represented by following Chemical Formula 1:
A-MO—R]₃ <Chemical Formula 1>
wherein A comprises a cyclic compound or a heterocyclic compound, having more than 4 carbon atoms, and M comprises titanium (Ti), zirconium (Zr) or hafnium (Hf), and R represents an alkyl group having 1 to 5 carbon atoms;
providing an oxidant including an oxygen atom to the substrate to oxidize the organic metal precursor;
reacting the organic metal precursor with the oxidant to form a gate insulation layer including a metal oxide on the substrate;
forming a conductive layer on the gate insulation layer; and
sequentially patterning the conductive layer and the gate insulation layer to form a gate structure including a gate conductive pattern and a gate insulation pattern.

18. The method of claim 17, wherein the organic metal precursor has a chemical structure represented by following Chemical Formula 4 or Chemical Formula 5:

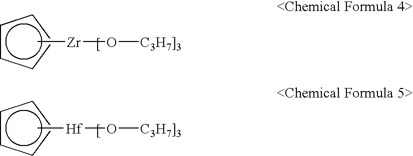

19. A method of manufacturing a capacitor, the method comprising:
forming a lower electrode on a substrate;
providing an organic metal precursor to the substrate having the lower electrode, the organic metal precursor having a vapor pressure of from about 0.5 Torr up to about 6 Torr at a temperature of from about 65° C. up to about 95° C., and having a chemical structure represented by following Chemical Formula 1:
A-MO—R]₃ <Chemical Formula 1>
wherein A represents a cyclic compound or a heterocyclic compound having more than 4 carbon atoms, and M represents titanium (Ti), zirconium (Zr) or hafnium (Hf), and R represents an alkyl group having 1 to 5 carbon atoms;
providing an oxidant including an oxygen atom to the substrate to oxidize the organic metal precursor;
reacting the organic metal precursor with the oxidant to form a dielectric layer including a metal oxide on the lower electrode; and
forming an upper electrode on the dielectric layer.

20. The method of claim 19, wherein the organic metal precursor has a chemical structure represented by following Chemical Formula 4 or Chemical Formula 5: [chemical structure]
